(19) United States
(12) Patent Application Publication
(10) Pub. No.: US 2025/0286211 A1
(43) Pub. Date: Sep. 11, 2025

(54) Mobile or Permanent Battery Energy Storage System

(71) Applicant: Dominion Energy Inc., Richmond, VA (US)

(72) Inventors: Jonathan H. Warren, Toana, VA (US); Joshua G. Bell, Richmond, VA (US); Christina M. Hanlon, Disputanta, VA (US); Jake R. Littlepage, Glen Allen, VA (US)

(73) Assignee: Dominion Energy Inc., Richmond, VA (US)

(21) Appl. No.: 18/601,040

(22) Filed: Mar. 11, 2024

(51) Int. Cl. H01M 50/383; A62C 3/16; B60L 53/30; B60L 53/302; B60L 53/51; B60P 3/00; H01M 10/42; H01M 10/46; H01M 10/613; H01M 10/625; H01M 10/6561; H01M 50/204; H01M 50/249; H02J 7/35; H02S 20/30

(52) U.S. Cl. CPC H01M 50/383; A62C 3/16; B60L 53/30; B60L 53/302; B60L 53/51; B60P 3/00; H01M 10/425; H01M 10/46; H01M 10/613; H01M 10/625; H01M 10/6561; H01M 50/204; H01M 50/249; H01M 2010/4271; H01M 2220/20; H02J 7/35; H02S 20/30

(57) ABSTRACT

Mobile or permanent battery energy storage systems provide electrical power to locations with or without connections to the electrical grid or provide a more consistent supply of electricity. A battery energy storage systems meet the requirements of UL 9540, UL 9540A, and other regulations and codes for use due to the structure and control systems incorporated into the battery energy storage system.

### FIELD OF THE INVENTION

Mobile or permanent battery energy storage systems that provide electrical power to locations with or without connections to the electrical grid or provide a more consistent supply of electricity. Embodiments of the battery energy storage systems meet the requirements of UL 9540, UL 9540A, and other regulations and codes for use.

### BACKGROUND

Batteries, such as but not limited to lithium-ion batteries, are the power source for nearly every portable electrical device including, but not limited to, automobiles, scooters, bicycles, laptops, portable power equipment, home backup power supplies, temporary power service in remote locations, and smartphones. Batteries are also used in mobile and permanent installations to provide storage for renewable energy sources to provide consistent power output.

The push for significantly more renewable electric power to combat climate change is exponentially increasing the demand for battery energy storage systems (BESS). Mobile BESS (MBESS) may be used for wedding venues, concerts, food trucks, and festivals that may require electricity for sound amplification, cooking, lights, heat, or other uses in places remote from the electrical grid or may need a greater supply of electrical power than is available at the venue. This electrical supply is conventionally supplied by fossil fuel generators for power production to run the equipment. However, these generators are inefficient, noisy, and exhaust noxious fumes and carbon dioxide. Fossil fuel generators also require constant refueling with a maintenance person supplying the generator from cans of gasoline which may result in spills.

As a result, the maintenance and operation of portable fossil fuel generators is expensive, inconvenient, and environmentally damaging due to fuel spills, organic vapors, exhaust, and routine tuning of the engine and breakdown repairs.

Emergency response personnel and organizations also require portable electrical power during emergency situations such as power outages and remote rescue operations. Again, currently the primary option to supply this electrical power are fossil fuel generators. The noise pollution and emissions make this a non-ideal solution, especially for short term housing solutions (tent cities) where people are trying to sleep or to be deployed for household use where both the noise and emissions would be intrusive to these residential areas. This is a growing concern as the need for restoration services and other emergency responses has increased in recent years.

There is a need for mobile or permanent BESS and other systems that provide electrical supply under normal conditions, in remote locations away from the electrical grid, under higher than normal demand, demand spikes, and temporary demand requirements.

### SUMMARY

Mobile and permanent BESS systems over a certain size must meet specific fire and safety regulations to be used for power supplies. An embodiment of a MBESS, for example, comprises a trailer, a trailer base on the trailer, battery rack system connected to the trailer base, a plurality of batteries, battery cells, and/or battery modules (hereinafter, “battery modules”) supported on the battery rack system, and an enclosure. The MBESS has specific design and structure features that allow the MBESS to be UL 9540 compliant. The battery rack system comprises a plurality of battery module bays that house and secure the battery modules that are specifically secured, arranged, and configured to meet such regulations.

In one embodiment, a MBESS, comprising a trailer comprising an enclosure and a trailer base comprising wheels and a trailer base. The MBESS comprises a plurality of battery modules in electrical communication. Due to the potential risks of overheating, fire, or generation of flammable gases during use or charging of the batteries, battery cells, and/or battery modules, a fire suppressant system may be included within the enclosure. The fire detection and suppressant system are configured to perform at least one of the following responses to sensors indicating a potential hazard within the enclosure, sounding a visual and/or audible alarm and igniting combustible off gas upon indication of dangerous buildup of hazardous off gas. The enclosure may further comprise a passive ventilation system that releases over pressurization within the enclosure, explosive, or combustion gases safely.

A battery rack is supported on the trailer base to secure at least one of the battery modules, bus bars, sensors for monitoring battery status and safety issues, a battery management control system, and electric inverters, for example. In one embodiment, the battery rack comprising a first shelf for receiving a first battery module and a second shelf for receiving a second battery module.

A battery module may have a container comprising a plurality of battery cells within a container. Each battery module may comprise a management system. Each battery module may be UL 9540 compliant, UL 1973 compliant, or both.

In one embodiment, the first battery module comprises a first container and the second battery module comprises a second container. The first container and the second container define a first flow channel for the air flow and cooling between the first shelf and the second shelf and the first container and the second container. The flow channel allows the air to cool the battery modules and to prevent or reduce the chance that an issue with one battery module will affect another battery module.

### BRIEF DESCRIPTION OF THE FIGURES

FIG. 1 depicts an embodiment of a battery module rack for a BESS or MBESS, the shown embodiment comprises six shelves for receiving six battery modules, support members for three DC to A/C inverters, bus bars, sensors, battery management systems, and other components of the BESS or MBESS;

FIG. 2 depicts the battery module rack of FIG. 1 with the six battery modules on the shelves;

FIG. 3 depicts an enclosure for a BESS or MBESS comprising doors for accessing the battery modules and inverters incorporated into the enclosure and a passive explosion mitigation vent in the roof;

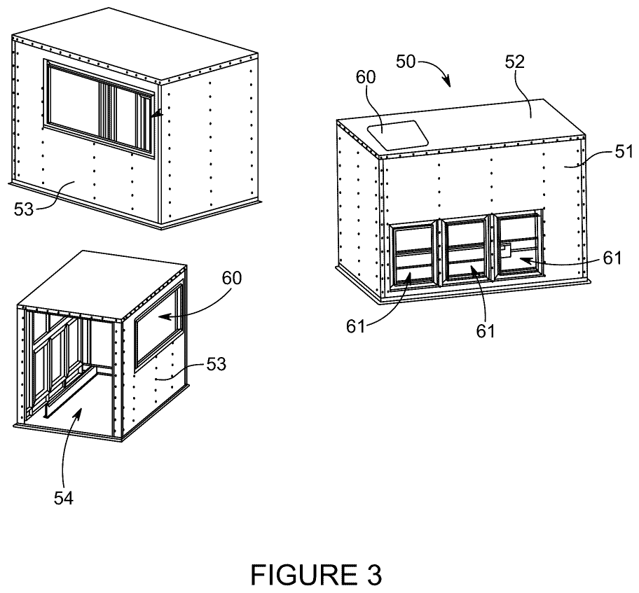

FIG. 4 is a flowsheet that depicts the basic control and monitoring system of the BESS or MBESS; and

FIG. 5 depicts an embodiment of the solar panels installed on the roof of the enclosure of the BESS or MBESS.

### DESCRIPTION

The battery rack may comprise a first row of a plurality of shelves for receiving a first row of a battery modules and a second row of a plurality of shelves for receiving a second row of batteries modules. The battery rack may comprise a third shelf and a third battery module may be received on the third shelf. In such an embodiment, the second container and the third container of the third battery module define a second flow channel for the air flow and cooling between the second shelf and the third shelf and the second container and the third container.

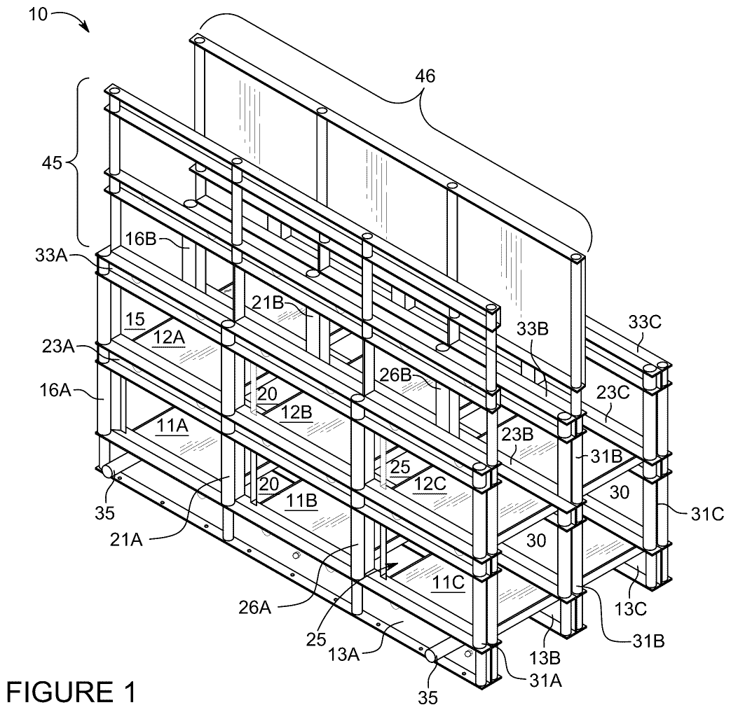

An embodiment of a battery rack 10 is shown in FIG. 1. The battery rack 10 of FIG. 1 comprises a first row comprising three battery shelves, a first battery shelf 11A, a second battery shelf 11B, and a third battery shelf 11C and a second row also comprising three battery shelves, a fourth battery shelf 12A, a fifth battery shelf 12B, and a sixth battery shelf 12C. The first vertical channel 20 is defined between the first column of battery shelves 11A 12A and a second column of battery shelves 11B 12B. A second vertical channel 25 is defined between the second column of battery shelves 11B 12B and a third column of battery shelves 11C 12C. The first vertical channel 20 and the second vertical channel 25 allow a space between the battery modules to prevent high temperatures excursions, fire, or explosion in one battery module from easily affecting an adjacent battery module. In the embodiment shown in FIG. 1, the vertical channels are formed as gaps between the adjacent shelves, however, these gaps may comprise a continuation of the shelves with apertures, vents, or grates, for example. The vertical channels allow air flow between the battery modules and may comprise additional features.

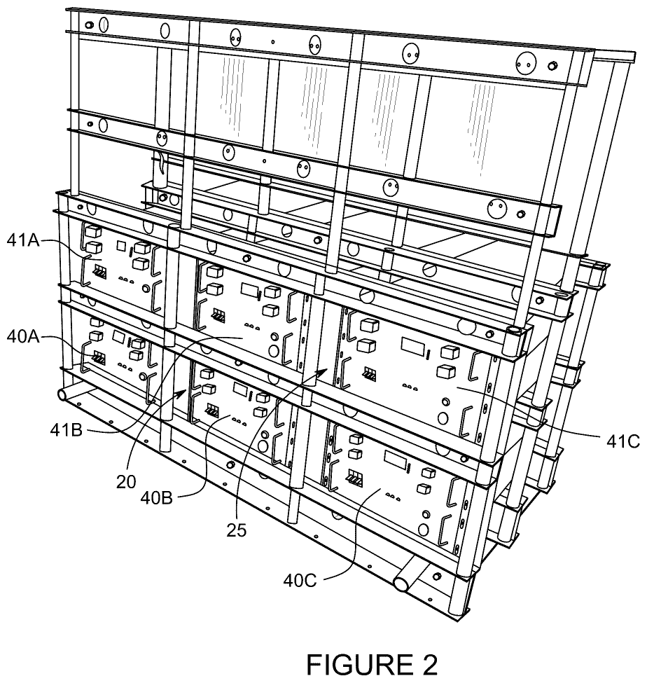

FIG. 2 depicts the six shelf battery rack of FIG. 1 with six battery modules installed on the shelves. The first row of shelves 11A 11B 11C receive battery modules 40A 40 B 40C and the second d row of shelves 12A 12B 12C receive battery modules 41A 41B 41C. The depicted battery modules are 48/51.2 Volts, 300 Amp-Hour, and are certified to UL 1973 and UL 9540a Standards. The battery modules each comprise 48 102 amp-hour battery cells and include a 200 amp battery management system within a battery module container. They are configured to be installed with forty-eight volt class inverters, battery chargers, and solar charge controllers. The shelves may comprise a gasket such as, but not limited to, a resilient rubber gasket. The gasket may lie flat on a shelf and has a lip around the sides to receive a battery module. Another gasket between the battery units may be a small strip that basically prevents movement or vibration of the battery modules. There is still an air gap between the battery module containers and the rack. The battery module containers further define vertical channels 20 25. The vertical channels are open to the right and left side of the battery rack to further enhance the air flow around the battery modules. Referring again to FIG. 1, the battery rack 10 comprises left side vertical support members 16A 21A 26A 31A, middle vertical supports 16B 21B 26B 31B, and rights side vertical supports 31C (16C 21C 26C not numbered). The middle vertical support 21B is within the first vertical channel 20 and middle vertical support 26B is within the first vertical channel 25. The left side vertical support members and the right side vertical support members are outside of the battery module shelves to provide and define further air flow channels on the left side and right side of the battery rack. Horizontal support members, such as lower horizontal support members 13A 13B 13C, central horizontal support members 23A 23B 23C, and upper horizontal support members 33A 33B 33C, provide support for the battery module shelves. Each battery module may weigh more than three hundred pounds and this embodiment of the battery rack must support the weight of six batteries and the inverters.

The battery rack 10 further comprises a first upper support rack 45 to support a bus bar to electrically connect the battery modules and inverters. The inverters convert DC electricity from the battery modules or the solar panels to AC electricity and may be supported on a second upper support rack 46. The inverters may be UL 1741 compliant.

In embodiments of either the permanent or the BESS or MBESS may comprise an enclosure for the battery rack, battery modules, and other components. The enclosure 50 may comprise a left side wall 51, a right side wall 53, and a roof 52. The battery module containers 40A-C 41A-C and the front wall 51 define a third flow channel for air flow and cooling. In another embodiment, the second container and the first side wall further define the third flow channel for air flow and cooling.

The battery rack may comprise four studs 35 on the sides of the battery rack system. The four studs 35 may be received into locking slots on the base of the trailer. The four studs may be locked with the locking slots by a cap, U-bolt, or any means known in the art.

The BESS or MBESS may comprise a passive explosion mitigation vent 60 installed in the roof 50 of the enclosure 52. A passive explosion mitigation vent is a safety device that opens or ruptures at a predetermined pressure to safely relieve pressure from within the enclosure 50 due an explosion, fire, or other source of over pressurization. The passive explosion mitigation vents are mounted on the roof above the battery rack, bus bars, and inverters. In the event of catastrophic thermal runway, the vents provide a safe “weak point” in the trailer enclosure for an explosive force to dissipate though. The explosive force and pressure are thus harmlessly released upwards and directed away from the sides of the trailer where people may be, not outwards through the doors.

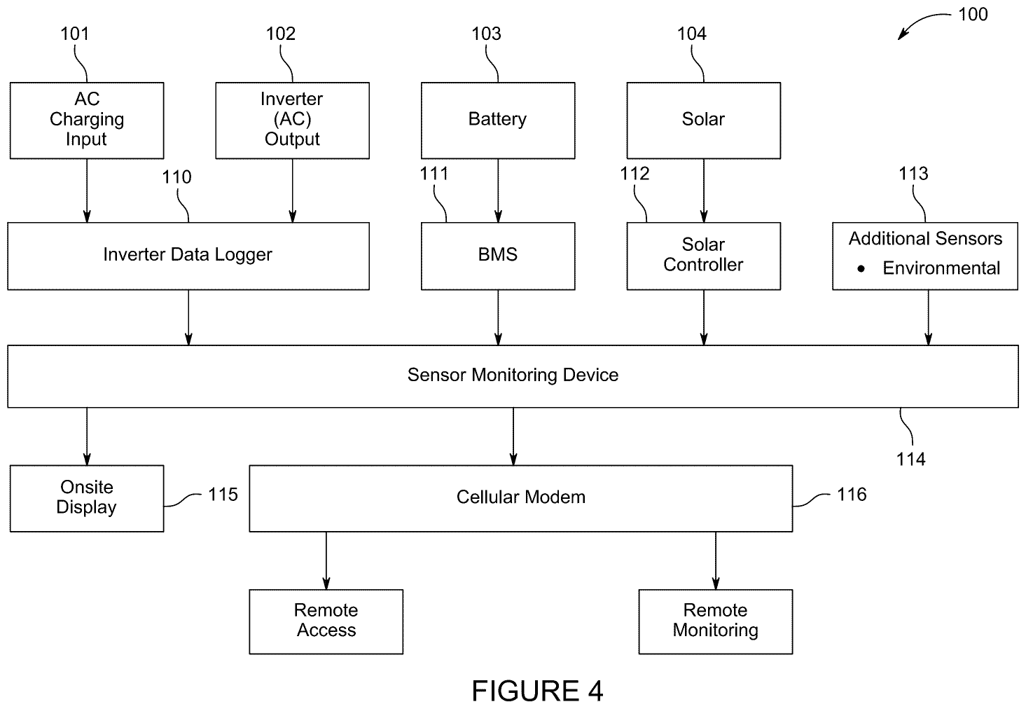

Embodiments of the BESS or MBESS comprise an electrical control system, A/C and solar power charging systems, status, and monitoring system (hereinafter, “monitoring system”). An embodiment of a status and monitoring system is shown in FIG. 4. The monitoring system 100 shown in FIG. 4 comprises an inverter data logger that receives input from the A/C charging input 101 and the A/C inverter output 102. The BESS or MBESS may be charged by plugging into an A/C power source such as the electrical grid, for example. The BESS or MBESS may be configured to output either A/C or DC power.

The individual battery modules may comprise an internal battery management system and the BESS or MBESS may comprise its own battery management system 111 that monitors and balances the charges between the plurality of battery modules 103.

The system further comprises additional sensors 113. Additional sensors 113 include, but may not be limited to, temperature sensors, voltage sensors, and amperage sensors, for example, to determine the state of the battery modules. For example, the battery management system 111 may continuously monitor the temperature of each of the battery modules 103 to ensure that the plurality of individual battery modules 103 are operated safely during both charging and discharging.

If one battery module overheats, the battery management system may isolate the overheating battery module and at least a portion of the load or charging may be switched from the overheating battery module to the a normally functioning battery module. In other embodiments, each of the battery modules may be configured into multiple individual packs and the battery management system may be configured to monitor each of these multiple packs.

The battery management system 111 may also control normal operation of the portable battery device. For example, during initial load or during peak loading, the battery management system 111 controls a balance between all the battery modules to provide the required amperage. During uncontrolled charging, lithium ion batteries may experience thermal spikes and, if overcharging occurs, there is a potential for a fire or explosion. The battery management system 111 may therefore monitor each of the battery modules during charging and adjust the charging voltage or amperage to each battery module to prevent overheating and damage to the cells. The battery management system may then balance the load appropriately.

In some embodiments, the battery management system may comprise at least one sensor monitoring device microcontroller unit (MCU) 114. Embodiments of the MCU or MCUs 114 may perform at least one of functions of monitoring the battery modules or individual cells of the battery modules, protecting the battery modules by controlling loads, estimate each of the battery modules state and remaining life, maximize each of the battery modules performance, data logging, controlling the load on each battery module, isolating a battery module that is showing signs of overloading or overheating, as well as other desired functions, for example. The MCU may comprise a local display reporting the status of the BESS or MBESS components and all the individual battery modules. The MCU may comprise a modem or other communication device 116 to communicate the status of the BESS or MBESS components and all the individual battery modules. The monitoring system may display or report, either locally or remotely, BESS or MBESS status information. The BESS or MBESS status information may include battery diagnostic information, solar system diagnostic information, power output/input information, fire safety information, and environmental information inside and outside the enclosure.

The BESS or MBESS status information may be triggering a fire alarm strobe or siren, software monitoring and reporting, triggering mechanisms to electrically disconnect failed or failing battery modules, UL9540A 4th edition test, battery installation level testing, and battery thermal runaway testing.

For individual cell safety in each battery module, the MCU or MCU 114 may prevent any individual cell or group of cells from an overvoltage situation inside the battery module. In such as case, the MCU may isolate an individual battery module or a group of battery modules, as necessary, to prevent the temperature of any battery module or group of battery modules, from exceeding the upper threshold limit by reducing/stopping the current or activating a cooling system in the battery module to prevent thermal runaway; prevent any cell, group of cells, or battery module from going into an under-voltage situation by limiting/stopping the discharge current; protect the individual battery modules from short circuit and overload situations by isolating the battery module from the voltage supply circuit. The vertical channels also prevent battery module overheating by allowing air flow around the battery modules.

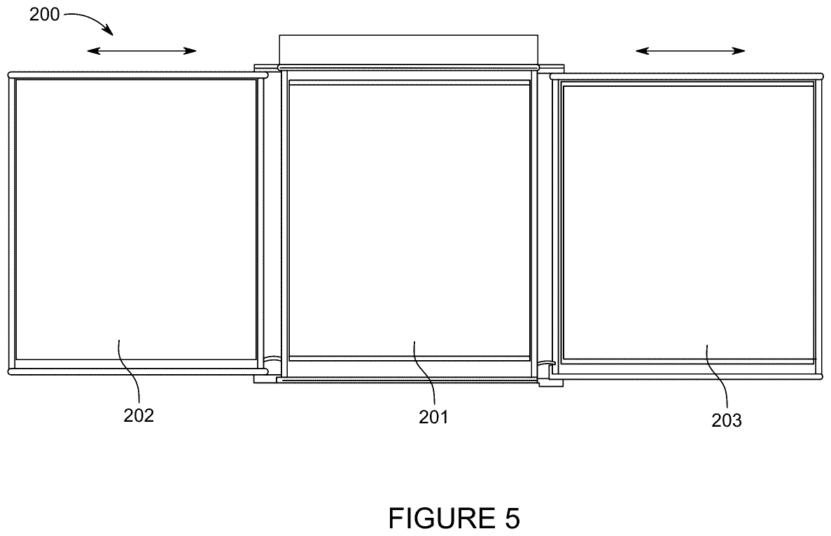

The monitoring system 114 may further monitor and report the status of the solar panels 104 which are connected to a solar power controller 112. In an embodiment, the BESS or MBESS comprises photovoltaic solar panels that produce electrical energy to charge the batteries or directly provide power to the inverters. In one embodiment, for example, the BESS or MBESS comprises three photovoltaic solar panels to charge the batteries or supply electrical power. The photovoltaic solar panels may be mounted slidably on top of the enclosure to allow storing the solar panels while the portable BESS or MBESS is being towed on the highway and sliding the solar panels to a deployed position for charging while the BESS or MBESS is being used. In the embodiment shown in FIG. 5, the solar array 200 is mounted on top of the enclosure 50 with one solar panel 52 fixedly connected to the roof of the enclosure and two solar panels 202 203 slidably mounted on the roof 52.

In a preferred embodiment, the BESS or MBESS comprise a fire safety and detection system and prevention system configured to activate the fire protection system. The fire detection system comprises optical sensors for monitoring the environmental conditions within the enclosure. Optical detectors may include infrared (“IR”) and ultraviolet infrared (“UV-IR”) detectors. The UV-IR detector monitors the environment for combustible gas or vapor protection systems. If the UV-IR detector measures a sufficient concentration of combustible gas within the enclosure the explosion prevention system activates a sparkler system configured to ignite a localized concentration of gases within the enclosure. In one embodiment the trailer fire safety system is configured to provide a safe operation of the trailer. The fire detection system may comprise a fire panel housing the UV and IR detection sensors and an active explosion prevention system comprising the sparkler system to ignite localized concentration of gases in the container.

The UV detection sensor and IR detection sensor are both mounted inside the trailer and wired to the fire panel. The fire protection system also comprises an active explosion prevention system. This system may also be connected to the fire panel. In the event of battery failure and a leaking of flammable off-gas, upon detection the sparkler system will ignite the gas before catastrophic build up. These systems in conjunction with each other provide a safe product in the event of catastrophic failure.

Embodiments of the BESS or MBESS are configured to safely stack six battery modules in an enclosed environment mounted on a UL-1973 approved rack system. The structure of the battery rack, enclosure, and safety systems ensure that if one battery module experiences thermal runway, it does not propagate to the batteries mounted nearby.

### Exemplary Embodiment

A MBESS comprises main components as follows:
A rack system wherein the battery modules are received in individual separate bays that house the batteries and secure them in place.
A main enclosure wherein the main enclosure is connected to the base of the trailer. The enclosure may comprise openings to access the batteries on one side and openings to access the inverters and a cut-off switch on the other side. A rear door provides access to install the rack system until the rear door and frame are installed after the rack system is bolted to the floor. Each of the access opening comprises a door to seal the access openings. The doors or the door access openings comprise a fire resistant seal.
The base of the trailer is connected onto the frame of the trailer and the main enclosure is connected to the base. The trailer may be a dual axle trailer.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

1. A mobile battery electrical storage system, comprising:
a trailer comprising an enclosure and a trailer base comprising wheels and a trailer base;
a fire protection system and a fire safety and detection system and prevention system configured to activate the fire protection system;
a battery rack, the battery rack comprising a first shelf for receiving a first battery module, a second shelf for receiving a second battery module, a third shelf for receiving a third battery module, wherein at least one inverter is mounted on the battery rack;
a first battery module on the first shelf, a second battery module on the second shelf, a third battery module of the third shelf and the first battery module and the second battery module define a first flow channel for the air flow and cooling and the second battery module and the third battery module define a second flow channel for the air flow and cooling.

2. The mobile battery electrical storage system of claim 1, wherein the enclosure comprises a first side wall and the first battery module and the front wall define a third flow channel for air flow and cooling.

3. The mobile battery electrical storage system of claim 2, wherein second container and the first side wall further define the third flow channel for air flow and cooling.

4. The mobile battery electrical storage system of claim 3, wherein the enclosure comprises a back wall and the first battery module and the back wall define a fourth flow channel for the air flow and cooling.

5. The mobile battery electrical storage system of claim 4, wherein the enclosure comprises a second side wall and the first battery module and the second side wall define a fifth flow channel for the air flow and cooling.

6. The mobile battery electrical storage system of claim 1, wherein the first shelf and the second shelf are fire resistant shelves.

7. The mobile battery electrical storage system of claim 2, wherein the first side wall comprises an access door providing access to the first battery module.

8. The mobile battery electrical storage system of claim 5, wherein the access door comprises a fire- and water-resistant seal.

9. The mobile battery electrical storage system of claim 1, wherein the enclosure comprises roof surface and the roof surface comprises at least one over pressure vent in the roof surface.

10. The mobile battery electrical storage system of claim 1, wherein the battery rack defines four or more battery modules.

11. The mobile battery electrical storage system of claim 1, wherein the battery rack defines six or more battery module bays.

12. The mobile battery electrical storage system of claim 1, wherein each battery module comprises a plurality of battery cells within the battery module.

13. The mobile battery electrical storage system of claim 11, wherein each battery bay has a battery module in the battery bay.

14. The mobile battery electrical storage system of claim 1, wherein the battery modules have a combined capacity over 20 kWh.

15. The mobile battery electrical storage system of claim 1, wherein the battery modules have a combined capacity over 50 kWh.

16. The mobile battery electrical storage system of claim 1, comprising at least one photovoltaic solar panel configured to charge the batteries.

17. The mobile battery electrical storage system of claim 1, comprising three photovoltaic solar panels configured to charge the batteries.

18. The mobile battery electrical storage system of claim 17, wherein the photovoltaic solar panels are mounted slidably on top of the trailer enclosure.

19. The mobile battery electrical storage system of claim 18, wherein one solar panel is rigidly connected to the top of the trailer body.

20. The mobile battery electrical storage system of claim 17, wherein the photovoltaic solar panels are externally mounted to the trailer.

21. The mobile battery electrical storage system of claim 1, wherein the at least one inverter converts D/C electricity to A/C electricity.

22. The mobile battery electrical storage system of claim 1, wherein each battery module is UL 1973 compliant.

23. The mobile battery electrical storage system of claim 1, wherein the battery rack is UL 1973 compliant.

24. The mobile battery electrical storage system of claim 1, wherein the mobile battery electrical storage system comprises a battery management system.

25. The mobile battery electrical storage system of claim 1, wherein the mobile battery electrical storage system passes UL 9540A testing.

26. The mobile battery electrical storage system of claim 1, wherein the battery rack comprises a plurality of rows of battery shelves.

27. The mobile battery electrical storage system of claim 1, comprising a fire detection system configured to activate the fire protection system.

28. The mobile battery electrical storage system of claim 27, wherein the fire detection system comprises infrared detections sensors and ultraviolet detection sensors.

29. The mobile battery electrical storage system of claim 27, wherein the fire protection system comprises at least one of a passive explosion mitigation system and an active explosion prevention system.

30. The mobile battery electrical storage system of claim 1, wherein the mobile battery electrical storage system receives UL 9540 listing.

31. The mobile battery electrical storage system of claim 1, wherein the inverters are UL 1741 compliant.
